(19) United States
(12) Patent Application Publication
(10) Pub. No.: US 2019/0121466 A1
(43) Pub. Date: Apr. 25, 2019

(54) TOUCH PANEL

(71) Applicant: JAPAN AVIATION ELECTRONICS INDUSTRY, LIMITED, Tokyo (JP)

(72) Inventor: Akitoshi SAKAUE, Tokyo (JP)

(73) Assignee: JAPAN AVIATION ELECTRONICS INDUSTRY, LIMITED, Tokyo (JP)

(21) Appl. No.: 16/149,323

(22) Filed: Oct. 2, 2018

(30) Foreign Application Priority Data
Oct. 20, 2017 (JP) 2017-203871

(51) Int. Cl. G06F 3/044

(52) U.S. Cl. CPC G06F 3/044; G06F 2203/04112

(57) ABSTRACT

A touch panel includes a first sensor electrode in a form of fine-line mesh formed in a first layer and a first dummy wiring that is formed in the first layer, insulated from the first sensor electrode, and disposed in a region other than a region in which the first sensor electrode is disposed. The first dummy wiring is formed by an array of first fine-line patterns, each of the first fine-line patterns being isolated from other first fine-line patterns, such that each of the first fine-line patterns includes one intersection of fine-lines, and the first sensor electrode and the first dummy wiring, being disposed so that a first gap is formed therebetween, constitute a first single continuous periodic fine-line mesh pattern such that a fine-line included by the first single continuous periodic fine-line mesh pattern is interrupted at a place where the fine-line intersects with the first gap.

### TECHNICAL FIELD

The present invention relates to a touch panel in which sensor electrodes that detect a touch location are made of fine-line mesh.

### BACKGROUND ART

FIGS. 1, 2A and 2B illustrate a configuration of a capacitive touch panel described in Japanese Patent Application Laid Open No. 2017-103317 (published on Jun. 8, 2017) as an example of conventional touch panels of this type. The touch panel comprises a first conductor layer, an insulating layer, a second conductor layer, and a protective coating which are stacked in this order on a transparent substrate 10. An area enclosed in a rectangular frame in FIG. 1 is a sensor region 20 in which sensor electrodes are located. Details of the sensor electrodes are omitted from FIG. 1.

The sensor electrodes include a first sensor electrode and a second sensor electrode. The first sensor electrode is formed from the first conductor layer and the second sensor electrode is formed from the second conductor layer.

As illustrated in FIG. 2A, the first sensor electrode 30 consists of a plurality of electrode rows 33 parallelly arranged in a Y direction parallel to a short side 22 of the sensor region 20, where each of the electrode rows 33 is made up of a plurality of island-like electrodes 31 arranged in a X direction parallel to a long side 21 of the sensor region 20 and linked with one another through linkage parts 32.

As illustrated in FIG. 2B, the second sensor electrode 40 consist of a plurality of electrode rows 43 parallelly arranged in the X direction, where each of the electrode rows 43 is made up of a plurality of island-like electrodes 41 arranged in the Y direction and linked with one another through linkage parts 42.

Each of the first sensor electrode 30 and the second sensor electrode 40 is formed of fine-line mesh, the electrode rows 33 and the electrode rows 43 are intersect each other and insulated from each other, and the linkage parts 32 and 42 are positioned in locations that coincide with each other.

Leads 51 are extended from both ends of each electrode row 33 of the first sensor electrode 30 in the X direction and a lead 52 is extended from one end of each electrode row 43 of the second sensor electrode 40 in the Y direction. A plurality of leads 51, 52 arranged in an array and extended from the sensor region 20 other than the leads 51, 52 at both ends of the array are omitted from FIG. 1.

Terminal parts 53 are arranged and formed in a center portion of one of the long sides of the rectangular transparent substrate 10 and the leads 51, 52 extend and are connected to each terminal part 53. Ground wirings 54 formed around the transparent substrate 10 to enclose the sensor region 20 and the leads 51, 52 are also connected to the terminal parts 53.

The leads 51, 52 and the terminal parts 53 are formed from the first conductor layer and the ground wirings 54 are formed in both of the first and second conductor layers.

The first and second conductor layers which have the configuration described above are formed by gravure offset printing using conductive ink containing conductive particles such as silver particles in this example.

### SUMMARY OF THE INVENTION

When an electrode pattern and a wiring pattern in a touch panel are formed by printing using conductive ink containing conductive particles such as silver particles, it is important to make sensor electrodes disposed in a sensor region have high transparency and difficult to visually recognize so as not to impair the visibility of a display part in which the touch panel is placed. For this reason, sensor electrodes formed by printing using conductive ink are typically in the form of fine-line mesh as in the touch panel described above.

On the other hand, sensor electrodes even in the form of fine-line mesh inevitably bring contrast between a region where the fine-line mesh exists and a region where the fine-line mesh does not exist and the contrast has no small influence on the visibility of the display part.

In that respect, the first sensor electrode 30 and the second sensor electrode 40 in the touch panel described above are configured in such a way that the linkage parts 32 and 42 are positioned in locations that coincide with each other and the electrode rows 33 and electrode rows 43 intersect each other, that is, the island-like electrodes 41 in the second conductor layer are disposed in locations where the fine-line mesh does not exist in the first conductor layer so as to fill the locations. Accordingly, contrast produced in the first conductor layer and contrast produced in the second conductor layer cancel each other out, thereby reducing contrast in the sensor region.

However, because the insulating layer exists between the first conductor layer and the second conductor layer, the visual contrast in the second conductor layer and the visual contrast in the first conductor layer viewed through the insulating layer are not equal. The contrast in the sensor region of the conventional touch panel has therefore not completely been eliminated.

In order to completely eliminate the contrast in the sensor region, a first dummy wiring formed by same fine-line mesh as that of the first sensor electrode 30 may be formed in a region other than a region where the first sensor electrode 30 is disposed in the first conductor layer and, similarly, a second dummy wiring formed by same fine-line mesh as that of the second sensor electrode 40 may be formed in a region other than a region where the second sensor electrode 40 is disposed in the second conductor layer.

More specifically, a single mesh pattern may be uniformly provided in the sensor region of each of the first conductor layer and the second conductor layer and fine-lines including by the mesh patterns may be interrupted to insulate and isolate the sensor electrode from the dummy wiring. In this case, if the gaps where the fine-lines are interrupted are too wide, contrast may be produced and the boundaries between the sensor electrode and the dummy wiring may become visible. Therefore, the gaps are preferably as small as possible and are preferably about 20 μm, for example.

However, it has been found that such a configuration causes problems such as a short circuit (insulation failure) between the sensor electrode and the dummy wiring, causing a change (enlargement) of the sensing area and capacitance of the sensor electrode and making it impossible to stably achieve desired performance of the touch panel. It has also been found that causes of such short circuits between the sensor electrode and the dummy wiring are phenomena such as transfer and printing of conductive ink that remains soft because of insufficient absorption of the solvent of the conductive ink into a blanket due to expansion of the blanket in gravure offset printing or intrusion of conductive foreign substances during printing, which are difficult to completely avoid without adding to costs.

In light of these circumstances, an object of the present invention is to provide a touch panel in which contrast in a sensor region is completely eliminated and, if an insulation failure between a sensor electrode and a dummy wiring occurs, the influence of the failure on the performance of the touch panel is minimized.

According to the present invention, a touch panel comprises: a first sensor electrode in a form of fine-line mesh formed in a first layer; and a first dummy wiring that is formed in the first layer, insulated from the first sensor electrode, and disposed in a region other than a region in which the first sensor electrode is disposed; wherein the first dummy wiring is formed by an array of first fine-line patterns, each of the first fine-line patterns being isolated from other first fine-line patterns, such that each of the first fine-line patterns includes one intersection of fine lines; and the first sensor electrode and the first dummy wiring, being disposed so that a first gap is formed therebetween, constitute a first single continuous periodic fine-line mesh pattern such that a fine-line included by the first single continuous periodic fine-line mesh pattern is interrupted at a place where the fine-line included by the first single continuous periodic fine-line mesh pattern intersects with the first gap.

With the touch panel according to the present invention, visual contrast in a sensor region can be completely eliminated and, if a short circuit between a sensor electrode and a dummy wiring disposed in a region other than a region in which the sensor electrode is disposed occurs due to a printing condition or printing environment, for example, the influence of the short circuit on the performance of the touch panel can be minimized, thus a good-quality of the touch panel without impairment of visibility of a display part can be stably achieved.

### BRIEF DESCRIPTION OF THE DRAWINGS

FIG. 1 is a diagram illustrating an example configuration of a touch panel;

FIG. 2A is a partial enlarged view illustrating an example conventional configuration of a first conductor layer of a touch panel;

FIG. 2B is a partial enlarged view illustrating an example conventional configuration of a second conductor layer of a touch panel;

FIG. 3 is a partial enlarged view illustrating a mesh pattern of a first layer in an example embodiment of a touch panel according to the present invention;

FIG. 4 is a partial enlarged view illustrating a mesh pattern of a second layer in an example embodiment of a touch panel according to the present invention;

FIG. 5 is a partial enlarged view illustrating a mesh pattern of a first layer in another example embodiment of a touch panel according to the present invention;

FIG. 6 is a partial enlarged view illustrating a mesh pattern of a second layer in another example embodiment of a touch panel according to the present invention;

FIG. 7A is a diagram illustrating a mesh pattern having regular-hexagonal unit grid cells;

FIG. 7B is a diagram illustrating a mesh pattern similar to the mesh pattern in FIG. 7A that is overlaid on the mesh pattern illustrated in FIG. 7A; and

FIG. 7C is a diagram illustrating the mesh patterns illustrated in FIGS. 7A and 7B overlaid on one another.

### DETAILED DESCRIPTION OF THE EMBODIMENTS

Example embodiments of the present invention will be described below.

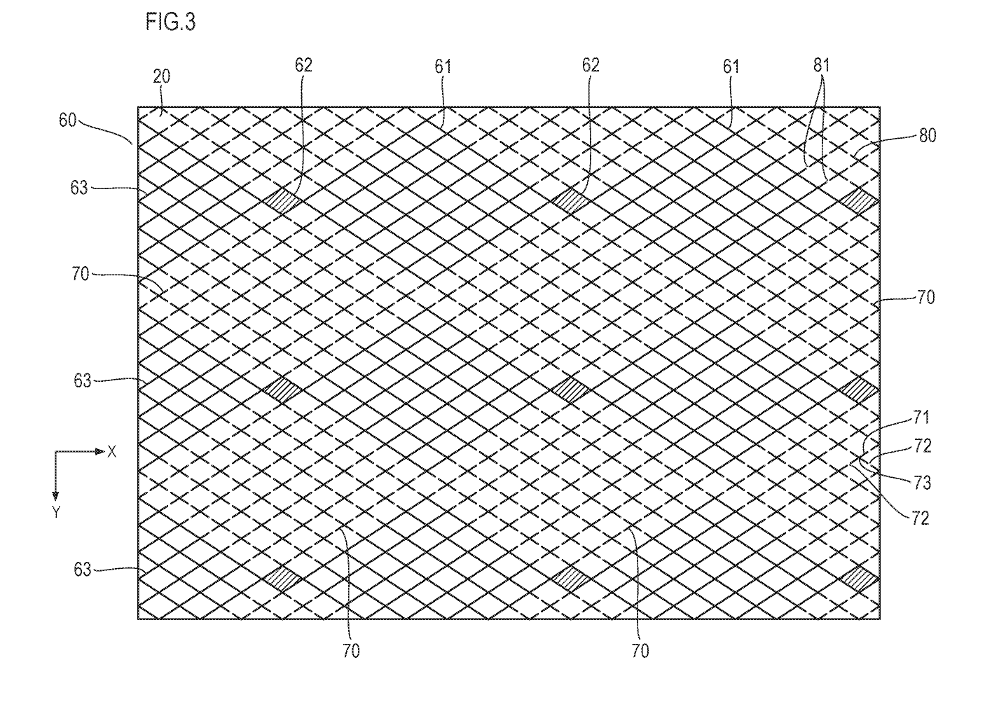

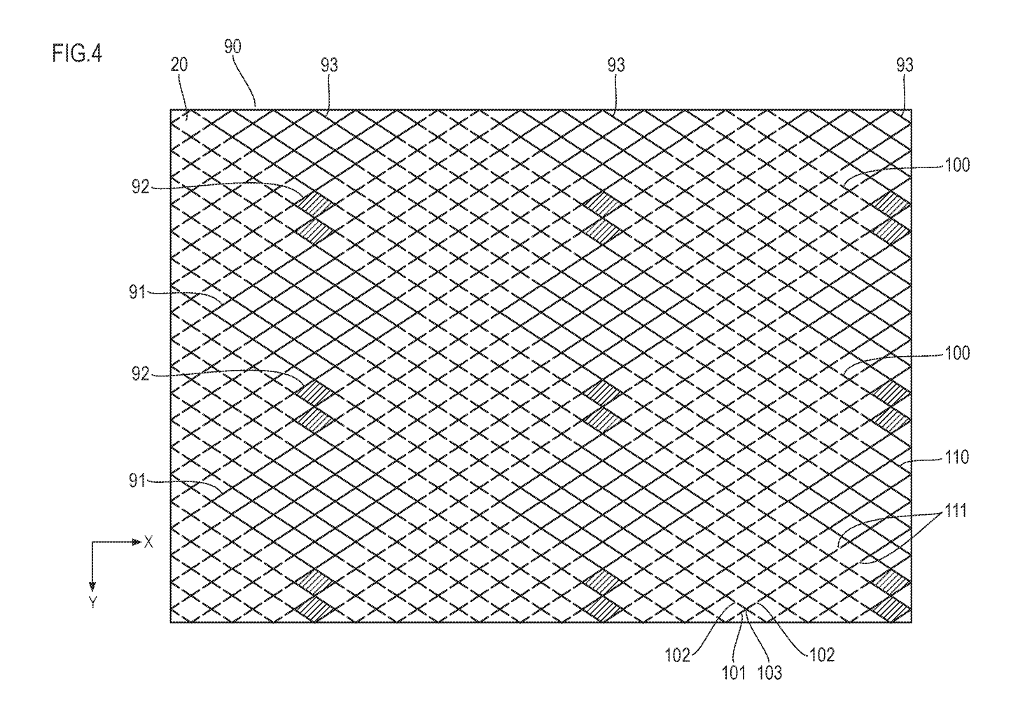

FIGS. 3 and 4 illustrate a main part of a configuration of an example embodiment of a touch panel according to the present invention in detail.

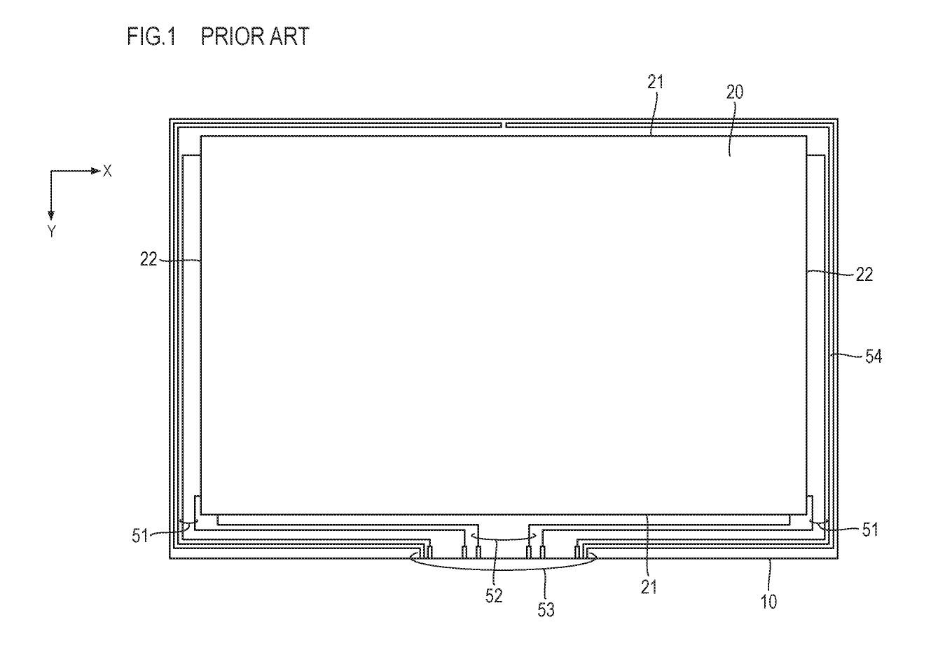

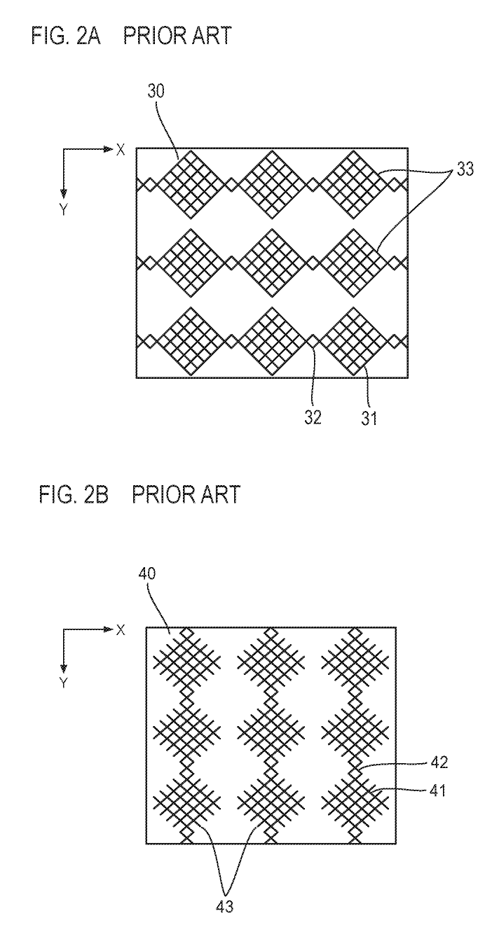

The touch panel in this example includes a first layer made of a conductor, an insulating layer made of an insulator, a second layer made of a conductor and a protective coating which are stacked in this order on one side of a transparent substrate. The insulating layer and the protective coating are made of a transparent material and the first and second layers made of a conductor are formed by gravure offset printing using conductive ink containing conductive particles such as silver particles. It should be noted that the touch panel differs from the example conventional touch panel illustrated in FIG. 1 in the configuration of the sensor region 20 and has a configuration that is basically similar to the configuration illustrated in FIG. 1, except for the sensor region 20.

FIG. 3 illustrates details of printed wiring of the first layer. A first sensor electrode 60 and a first dummy wiring 70 are formed in a sensor region 20. The first sensor electrode 60, which is in a form of fine-line mesh, consists of a plurality of electrode rows 63 arranged in parallel in the Y direction, in each of which a plurality of island-like electrodes 61 are arranged in the X direction and interlinked through linkage parts 62. The first dummy wiring 70 is disposed in a region in the sensor region 20 other than a region in which the first sensor electrode 60 is disposed and is insulated from the first sensor electrode 60. Note that regions in which the linkage parts 62 of the first sensor electrode 60 are positioned are hatched in FIG. 3.

The first dummy wiring 70 is formed by an array of first fine-line patterns 71 and each of the first fine-line patterns 71 in this example has a shape of a letter X in which two fine-lines intersect. Each of the first fine-line patterns 71 is isolated from other first fine-line patterns 71.

The first sensor electrode 60 and the first dummy wiring 70 constitute a first single continuous periodic fine-line mesh pattern (hereinafter referred to as the first mesh pattern, for short) 80 while a first gap 81 is formed and disposed between the first sensor electrode 60 and the first dummy wiring 70. A unit cell of the first mesh pattern 80 in this example has a shape of a rhombus with a side length of 400 μm and a width of each of the fine-lines making up the mesh is 7 μm. The fine-line included by the first mesh pattern 80 is interrupted at a place where the fine-line included by the first mesh patterns 80 intersects with the first gap 81. The first fine-line pattern 71, which is in the shape of the letter X, has a shape that belongs to the first mesh pattern 80. A gap 72 provided between adjacent first fine-line patterns 71 and the first gap 81 between the first sensor electrode 60 and the first dummy wiring 70 are both 20 μm.

FIG. 4, on the other hand, illustrates details of printed wiring of the second layer and a second sensor electrode 90 and a second dummy wiring 100 are formed in the sensor region 20. The second sensor electrode 90, which is in a form of fine-line mesh, consists of a plurality of electrode rows 93 arranged in parallel in the X direction, in each of which a plurality of island-like electrodes 91 are arranged in the Y direction and interlinked through linkage parts 92. The second dummy wiring 100 is disposed in a region in the sensor region 20 other than a region in which the second sensor electrode 90 is disposed and is insulated from the second sensor electrode 90. Note that regions in which the linkage parts 92 of the second sensor electrode 90 are positioned are hatched in FIG. 4 as in FIG. 3.

The second dummy wiring 100 is formed by an array of second fine-line patterns 101 and each of the second fine-line patterns 101 in this example has a shape of the letter X like the first fine-line pattern 71. Each of the second fine-line patterns 101 is isolated from other second fine-line patterns 101.

The second sensor electrode 90 and the second dummy wiring 100 constitute a second single continuous periodic fine-line mesh pattern (hereinafter referred to as the second mesh pattern, for short) 110 while a second gap 111 is formed and disposed between the second sensor electrode 90 and the second dummy wiring 100. The second mesh pattern 110 in this example is identical to the first mesh pattern 80 and the angle which each of the fine-lines making up the mesh forms with the long side 21 of the sensor region 20 is also identical to that in the first mesh pattern 80. The fine-line included by the second mesh pattern 110 is interrupted at a place where the fine-line included by the second mesh pattern 110 intersects with the second gap 111. The second fine-line pattern 101, which is in the shape of the letter X, has a shape that belongs to the second mesh pattern 110. A gap 102 provided between adjacent second fine-line patterns 101 and the second gap 111 between the second sensor electrode 90 and the second dummy wiring 100 are both 20 μm.

The printed wiring of the first layer and the printed wiring of the second layer described above are overlaid on each other with the insulating layer disposed between them, where the first mesh pattern 80 of the first layer and the second mesh pattern 110 of the second layer are overlaid on each other in such a way that they intersect at the midpoint that divides the side of the rhombus shape of each unit cell into two 200-μm segments. Consequently, rhombus-shaped cells with a side length of 200 μm are uniformly formed in the entire sensor region 20. It should be noted that the electrode rows 63 of the first sensor electrode 60 and the electrode rows 93 of the second sensor electrode 90 intersect, with the linkage parts 62 and 92 being positioned in locations that coincide with each other.

With the touch panel having the configuration as described above, the first mesh pattern 80 uniformly exists in the sensor region 20 of the first layer in which the first sensor electrode 60 is formed, the second mesh pattern 110 uniformly exists in the sensor region 20 of the second layer in which the second sensor electrode 90 is formed and, while some portions of the first mesh pattern 80 and the second mesh pattern 110 include gaps 72, 81 and 102, 111, respectively, in which fine-lines are interrupted, the gaps 72, 81, 102, 111 are as narrow as 20 μm and therefore are invisible. Accordingly, visual contrast due to the presence and the absence of the fine-line mesh and the interruption of the fine-line does not occur in each of the first and second layers and naturally visual contrast does not occur when the first and second layers are overlaid on each other as well.

On the other hand, since both of the first dummy wiring 70 and the second dummy wiring 100 are formed by arrays of the first fine-line patterns 71 and the second fine-line patterns 101, respectively, that are insulated from one another, a local insulation failure between the first sensor electrode 60 and the first dummy wiring 70 or between the second sensor electrode 90 and the second dummy wiring 100, if any, causes only the poorly-insulated one fine-line pattern adjacent to the sensor electrode to be short-circuited with the sensor electrode and therefore a change in the sensing area and a change in capacitance are minimized. In other words, in the event of an insulation failure, the influence of the insulation failure on the performance of the touch panel can be minimized.

It should be noted that conductive ink collects at the intersection of fine-lines in a mesh pattern during printing of the mesh pattern and, if fine-line patterns of the dummy wiring have no intersection of fine-lines, the distribution density of an amount of ink printed in a region in which the dummy wiring are disposed becomes lower than the distribution density of an amount of ink printed in a region in which the sensor electrode is disposed and ink bleed due to collection of ink does not occur in a region in which the dummy wiring is disposed. These factors would cause visual contrast between the two regions. In the present example, in contrast, each of the first fine-line patterns 71 and the second fine-line patterns 101 which constitute the first dummy wiring 70 and the second dummy wiring 100, respectively, has the shape of the letter X and therefore has one intersection 73 and 103, respectively, which prevents contrast due to the presence and the absence of collection of ink from occurring in the first layer in which the first sensor electrode 60 is formed and the second layer in which the second sensor electrode 90 is formed. Thus, contrast in the sensor region 20 can be completely eliminated in the present example.

In addition, since the first mesh pattern 80 and the second mesh pattern 110 are overlaid on each other in such a way that they intersect at the midpoint that divides each side of the rhombus shape of each unit cell into two 200-μm segments as described above, the fine-lines that constitute the first mesh pattern 80 and the fine-lines that constitute the second mesh pattern 110 are not close to each other. Therefore, a pair of adjacent fine-lines do not appear as a visible, relatively dark line as if they were a single thick line.

The first mesh pattern (the first single continuous periodic fine-line mesh pattern) formed in the first layer in which the first sensor electrode 60 and the first dummy wiring 70 are provided and the second mesh pattern (the second single continuous periodic fine-line mesh pattern) formed in the second layer in which the second sensor electrode 90 and the second dummy wiring 100 are provided will now be described in further detail.

Each of the first mesh pattern and the second mesh pattern has a pattern that is obtained by a tessellation of a plane using a unit cell of one type as a tile in accordance with a pair of tiling periodicity directions. The pair of tiling periodicity directions are nonparallel to each other. Each of the pair of tiling periodicity directions defines a direction in which a translational period of the unit cell corresponding to the tiling periodicity directions occurs. The first mesh pattern and the second mesh pattern are identical to each other in the pair of tiling periodicity directions and the translational periods corresponding thereto.

The first mesh pattern and the second mesh pattern are aligned with and overlaid on each other with a predetermined deviation from perfect alignment. In the example described above, the first mesh pattern and the second mesh pattern have the unit cell that has the shape of the rhombus with the side length of 400 μm, and the first mesh pattern and the second mesh pattern are overlaid on each other in such a way that they intersect at the midpoint that divides each side of the rhombus shape into two 200-μm sections. That is, the first mesh pattern and the second mesh pattern are aligned with and overlaid on each other in such a way that the first mesh pattern and the second mesh pattern are deviated from each other in both of the pair of tiling periodicity directions, respectively by ½ of the translational period corresponding to the tiling periodicity directions. This isolates the fine-lines making up the first mesh pattern and the fine-lines making up the second mesh pattern away from one another with a maximum gap and allows rhombus shapes with the side length of 200 μm to be uniformly formed when they are overlaid on one another. When overlaying the first mesh pattern and the second mesh pattern on each other, the first mesh pattern and the second mesh pattern need only to be aligned in such a way that the first mesh pattern and the second mesh pattern are deviated from each other in both of the pair of tiling periodicity directions, respectively by from ¼ to ¾, inclusive, of the translational period corresponding to the tiling periodicity directions. This can well avoid proximity between fine-lines due to the overlaying.

While the unit cell is the rhombus shape in the example described above, the shape of the unit cell is not limited to this and any of a wide variety of shapes can be employed. For example, the shape of the unit cell may be a square or a regular hexagon. The relative angle between the pair of tiling periodicity directions of these unit cells is 90° for the square and 60° for the regular hexagon. The translational period is equal to the distance between parallel opposed sides (in the case of the square, the side length of the square).

Like FIGS. 3 and 4, FIGS. 5 and 6 illustrate details of printed wirings of a first layer and a second layer in another example embodiment of a touch panel according to the present invention, in which a mesh pattern with regular-hexagonal unit cells uniformly exists. Components that correspond to components in FIGS. 3 and 4 are labeled with the same reference numerals with a prime (′) and detailed description thereof will be omitted.

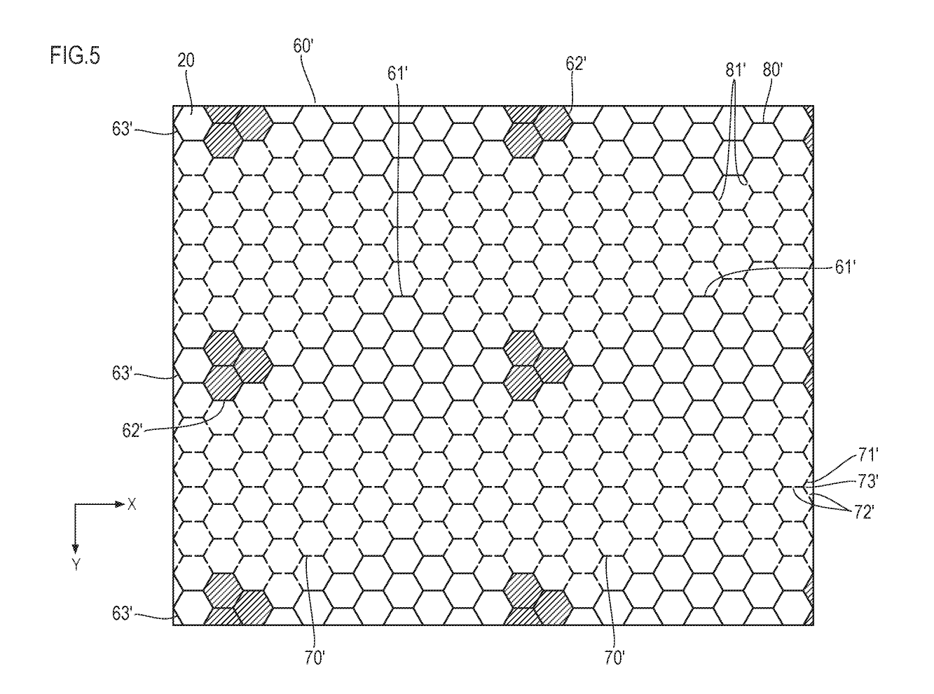

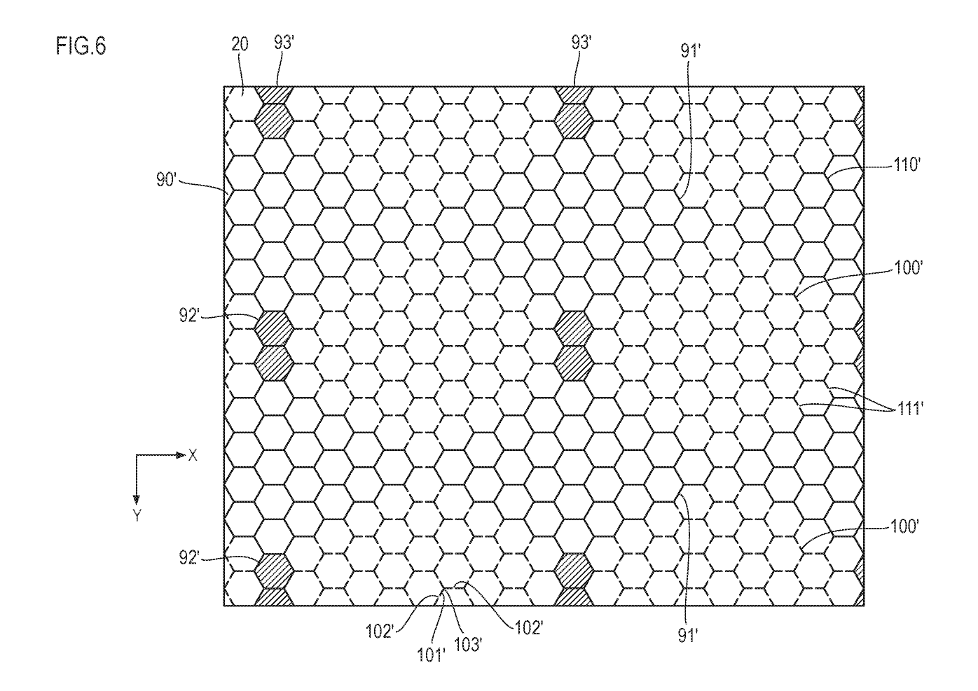

In this example, first fine-line patterns 71′ and second fine-line patterns 101′ that constitute a first dummy wiring 70′ and a second dummy wiring 100′, respectively, have a shape of a letter Y in which three fine-lines join. Like the first fine-line patterns 71 and the second fine-line patterns 101 in FIGS. 3 and 4, the first and second fine-line patterns 71′, 101′ each have a shape that includes one intersection 73′, 103′ of fine-lines and belongs to a first mesh pattern 80′ and a second mesh pattern 110′, respectively. Note that as in FIGS. 3 and 4, regions in which linkage parts 62′ of a first sensor electrode 60′ are positioned and regions in which linkage parts 92′ of a second sensor electrode 90′ are positioned are hatched in FIGS. 5 and 6.

Making the unit cells of the first mesh pattern 80′ of the first layer and the second mesh pattern 110′ of the second layer into a regular hexagonal shape as described above and making the first fine-line patterns 71′ and the second fine-line patterns 101′ into the shape of the letter Y can also provide a touch panel in which contrast in a sensor region 20 is completely eliminated and the influence of a short circuit, if any, between the sensor electrode and the dummy wiring is minimized as in the touch panel described earlier.

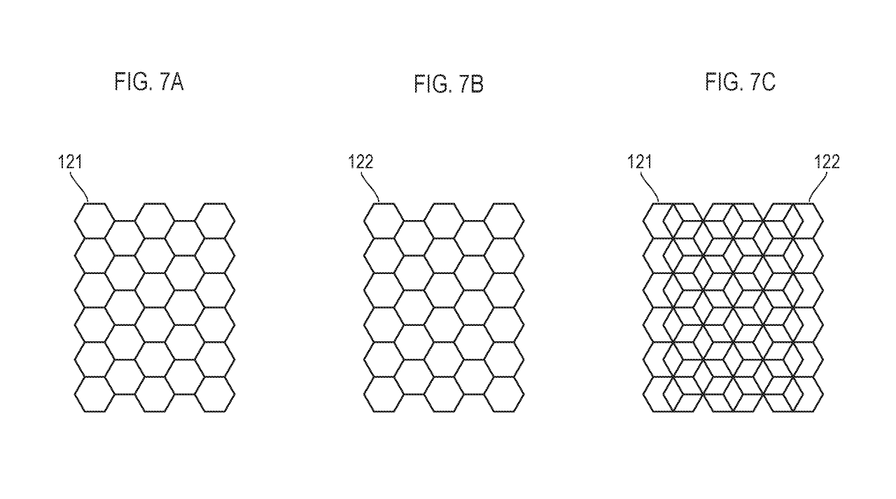

FIGS. 7A and 7B schematically illustrate mesh patterns with such regular-hexagonal unit cells. FIG. 7C illustrates mesh patterns 121, 122 illustrated in FIGS. 7A and 7B aligned with and overlaid on each other in such a way that the mesh pattern 121 and the mesh pattern 122 are deviated from each other in both of the pair of tiling periodicity directions, respectively by ½ of the translational period corresponding to the tiling periodicity directions. As a result of the overlaying, each of the regular hexagons is divided into three rhombus shapes and such rhombus shapes are uniformly formed.

What is claimed is:

1. A touch panel comprising:
a first sensor electrode in a form of fine-line mesh formed in a first layer; and
a first dummy wiring that is formed in the first layer, insulated from the first sensor electrode, and disposed in a region other than a region in which the first sensor electrode is disposed;
wherein the first dummy wiring is formed by an array of first fine-line patterns, each of the first fine-line patterns being isolated from a rest of the first fine-line patterns, such that each of the first fine-line patterns includes one intersection of fine-lines; and
the first sensor electrode and the first dummy wiring, being disposed so that a first gap is formed therebetween, constitute a first single continuous periodic fine-line mesh pattern such that a fine-line included by the first single continuous periodic fine-line mesh pattern is interrupted at a place where the fine-line included by the first single continuous periodic fine-line mesh pattern intersects with the first gap.

2. The touch panel according to claim 1, further comprising:
a second sensor electrode in a form of fine-line mesh formed in a second layer; and
a second dummy wiring that is formed in the second layer, insulated from the second sensor electrode, and disposed in a region other than a region in which the second sensor electrode is disposed;
wherein the second dummy wiring is formed by an array of second fine-line patterns, each of the second fine-line patterns being isolated from a rest of the second fine-line patterns, such that each of the second fine-line patterns includes one intersection of fine-lines;
the second sensor electrode and the second dummy wiring, being disposed so that a second gap is formed therebetween, constitute a second single continuous periodic fine-line mesh pattern such that a fine-line included by the second single continuous periodic fine-line mesh pattern is interrupted at a place where the fine-line included by the second single continuous periodic fine-line mesh pattern intersects with the second gap; and
the first layer and the second layer are overlaid on each other with a transparent insulator disposed between the first layer and the second layer.

3. The touch panel according to claim 2,
wherein each of the first single continuous periodic fine-line mesh pattern and the second single continuous periodic fine-line mesh pattern has a pattern that is obtained by a tessellation of a plane using a unit cell of one type as a tile in accordance with a pair of tiling periodicity directions, the pair of tiling periodicity directions being nonparallel to each other, such that each of the pair of tiling periodicity directions defines a direction in which a translational period of the unit cell corresponding to the tiling periodicity direction occurs;
the first single continuous periodic fine-line mesh pattern and the second single continuous periodic fine-line mesh pattern are identical to each other in the pair of tiling periodicity directions and the translational periods corresponding thereto; and
the first single continuous periodic fine-line mesh pattern and the second single continuous periodic fine-line mesh pattern are aligned with and overlaid on each other in such a way that the first single continuous periodic fine-line mesh pattern and the second single continuous periodic fine-line mesh pattern are deviated from each other in both of the pair of tiling periodicity directions, respectively by from ¼ to ¾, inclusive, of the translational period corresponding to the tiling periodicity direction.

4. The touch panel according to claim 3,
wherein the unit cells of both of the first single continuous periodic fine-line mesh pattern and the second single continuous periodic fine-line mesh pattern have an identical rhombus shape; and
each of the first fine-line patterns and the second fine-line patterns has a shape of a letter X in which two fine-lines intersect.

5. The touch panel according to claim 3,
wherein the unit cells of both of the first single continuous periodic fine-line mesh pattern and the second single continuous periodic fine-line mesh pattern are an identical regular hexagon; and
each of the first fine-line patterns and the second fine-line patterns has a shape of a letter Y in which three fine-lines join.
